(19) United States
(12) Patent Application Publication
(10) Pub. No.: US 2015/0220026 A1
(43) Pub. Date: Aug. 6, 2015

(54) TRANSFER MEMBER AND IMAGE FORMING APPARATUS

(71) Applicant: Konica Minolta, Inc., Tokyo (JP)

(72) Inventors: Akihiro HONYA, Tokyo (JP); Ryo NAKAYAMA, Tokyo (JP); Sadaaki SAKAMOTO, Tokyo (JP)

(21) Appl. No.: 14/611,828

(22) Filed: Feb. 2, 2015

(30) Foreign Application Priority Data
Feb. 5, 2014 (JP) 2014-020167

(51) Int. Cl. G03G 15/01

(52) U.S. Cl. CPC G03G 15/1605

(57) ABSTRACT

An endless belt-shaped transfer member of an electrophotographic image forming apparatus includes an elastic body layer and a surface layer formed on the elastic body layer. The transfer member has (i) an indentation depth of 400 nm or more and 1,500 nm or less with a load of 100 μN applied to a surface of the transfer member with a Berkovich indenter and (ii) a hardness of 40° or more and 85° or less on the surface of the transfer member measured with a micro-rubber hardness tester.

### 1. FIELD OF THE INVENTION

The present invention relates to a transfer member and an image forming apparatus provided with the transfer member.

### 2. DESCRIPTION OF THE RELATED ART

In an electrophotographic image forming apparatus, for example, latent images formed on image holders (photosensitive bodies) are developed with toners, the obtained toner images are temporarily held on an endless belt-shaped transfer member (hereinafter also referred to as the “intermediate transfer belt”), and the toner images on the intermediate transfer belt are transferred onto recording media such as sheets of paper.

This sort of intermediate transfer belt adopts a structure in which an elastic body of chloroprene rubber (CR) or the like is formed on the surface of a substrate layer of polyimide resin or the like as a measure to improve transfer functions such as applicability to paper and image quality.

This sort of intermediate transfer belt has a problem that foreign matters easily adhere to the surface thereof because the surface is in a rubbery state. Then, a surface layer is formed on the elastic body. (Refer to Japanese Patent Application Laid-Open Publication Nos. 2000-310912, 2004-334029, 2003-131492, 2007-25288, 11-267583 and 10-207242.)

However, when a hard surface layer is formed, followability of the surface layer after the elastic body cannot be obtained, so that the surface layer may be broken or come off and accordingly high durability cannot be obtained, whereas when a flexible surface layer is formed, wear resistance cannot be obtained, so that high durability cannot be obtained.

### BRIEF SUMMARY OF THE INVENTION

The present invention has been conceived in view of the above circumstances, and hence an object of the present invention is to provide a transfer member which ensures a surface layer followability after an elastic body layer. Consequently, the transfer member can have such high durability that the surface layer neither separates from the elastic body layer nor gets damaged, and also can have excellent transfer functions. Another object of the present invention is to provide an image forming apparatus which can stably form high-quality images for a long time.

In order to achieve at least one of the objects, according to an aspect of the present invention, there is provided an endless belt-shaped transfer member of an electrophotographic image forming apparatus, the transfer member including: an elastic body layer; and a surface layer formed on the elastic body layer, wherein the transfer member has (i) an indentation depth of 400 nm or more and 1,500 nm or less with a load of 100 μN applied to a surface of the transfer member with a Berkovich indenter and (ii) a hardness of 40° or more and 85° or less on the surface of the transfer member measured with a micro-rubber hardness tester.

Preferably, in the transfer member, the surface layer contains cured (meth)acrylic resin and a surface-treated metal oxide particle, and the cured (meth)acrylic resin is obtained by curing a curable composition containing polyfunctional (meth)acrylate, polyurethane acrylate and a low surface energy group-containing polymerizable component.

Preferably, in the transfer member, the polyurethane acrylate has a number average molecular weight of 3,000 and more and 30,000 or less.

Preferably, in the transfer member, the polyfunctional (meth)acrylate is tri- or higher-functional (meth)acrylate.

Preferably, in the transfer member, the polyfunctional (meth)acrylate has a number average molecular weight of 3,000 or less.

Preferably, in the transfer member, a content of a structural unit derived from the polyfunctional (meth)acrylate in the curable composition is 20 to 60 percent by mass.

Preferably, in the transfer member, a (meth)acryloyl group of the polyurethane acrylate is present on a terminal of a molecular chain.

Preferably, in the transfer member, a content of a structural unit derived from the polyurethane acrylate in the curable composition is 30 to 70 percent by mass.

Preferably, in the transfer member, the low surface energy group-containing polymerizable component contains a polyorganosiloxane chain or a polyfluoroalkyl chain.

Preferably, in the transfer member, the low surface energy group-containing polymerizable component contains three or more radical polymerizable double bonds.

Preferably, in the transfer member, the low surface energy group-containing polymerizable component has a number average molecular weight of 5,000 or more and 100,000 or less.

Preferably, in the transfer member, the metal oxide particle has a number average primary particle size of 1 nm or more and 300 nm or less.

Preferably, in the transfer member, the metal oxide particle is surface-treated with silicone oil.

Preferably, in the transfer member, the metal oxide particle is surface-treated with a radical polymerizable functional group-containing silane coupling agent.

Preferably, in the transfer member, the surface layer has a thickness of 1 μm or more and 5 μm or less.

Preferably, in the transfer member, the surface layer is cured by being irradiated with an active energy ray and thereby is formed.

Preferably, in the transfer member, a polymerization initiator used for curing the surface layer and thereby forming the surface layer is an acylphosphine oxide compound.

Preferably, in the transfer member, the elastic body layer contains chloroprene rubber.

According to another aspect of the present invention, there is provided an electrophotographic image forming apparatus including: a primary transfer section which primary-transfers a toner image electrostatically formed on an image holder to an intermediate transfer belt which circularly moves; and a secondary transfer section which secondary-transfers the toner image primary-transferred to the intermediate transfer belt to an image support, wherein the intermediate transfer belt is constituted of the transfer member.

### BRIEF DESCRIPTION OF THE SEVERAL VIEWS OF THE DRAWING

The present invention is fully understood from the detailed description given hereinafter and the accompanying drawings, which are given by way of illustration only and thus are not intended to limit the present invention, wherein:

FIG. 1A is a schematic view to explain a deformation state of a transfer member;

FIG. 1B is a schematic view to explain a deformation state of a transfer member;

FIG. 2 is a cross sectional view showing an example of the configuration of a transfer member of the present invention;

FIG. 3 is a cross sectional view showing an example of the configuration of an application apparatus used for forming a surface layer of the transfer member of the present invention; and

FIG. 4 is a cross sectional view showing an example of the configuration of an image forming apparatus of the present invention.

### DETAILED DESCRIPTION OF THE INVENTION

Hereinafter, the present invention is detailed.

### [Transfer Member]

A transfer member of the present invention is an endless belt-shaped transfer member of an electrophotographic image forming apparatus and constituted of a surface layer and an elastic body layer formed on the surface layer. The transfer member has an indentation depth and a hardness of specific ranges. The indentation depth is an indentation depth when a load of 100 μN is applied to the surface of the transfer member with a Berkovich indenter, and the hardness is a hardness on the surface of the transfer member measured with a micro-rubber hardness tester.

The indentation depth of the transfer member is 400 nm or more and 1,500 nm or less, preferably 400 nm or more and 1000 nm or less.

The indentation depth of the transfer member within the above range allows the surface (surface layer) of the transfer member to have appropriate stretchability, and accordingly the surface layer follows deformation of the elastic body layer. Consequently, cracks can be prevented from being generated.

The indentation depth in the present invention indicates a micro-hardness on the surface of the transfer member, namely, a micro-deformation amount of the surface layer.

In the present invention, the indentation depth of the transfer member is a value obtained as follows.

The measurement is carried out with a nano-indentation method under an environment of a temperature of 23° C. and a humidity of 50% RH. More specifically, the indentation depth when a load of 100 μN is applied to the surface of the transfer member with a Berkovich indenter is measured with a “Triboscope” (from Hysitron Corporation) under the following conditions.

### —Conditions—

Indenter: Berkovich (Berkovich indenter)

Load: maximum load of 400 μN

Loading Time: 5 seconds

Unloading Time: 5 seconds

The hardness of the transfer member is 40° or more and 85° or less, preferably 60° or more and 80° or less.

The hardness of the transfer member within the above range allows the transfer member to have appropriate deformability. Consequently, the transfer member can have excellent transferability to uneven paper or the like too.

The hardness in the present invention indicates hardness of the whole transfer member and, to be more specific, depends on the hardness of the elastic body layer.

In the present invention, the hardness of the transfer member is a value obtained as follows.

The measurement is carried out with a micro-rubber hardness tester “MD-1 capa” (from Kobunshi Keiki Co., Ltd.) under an environment of a temperature of 23° C. and a humidity of 50% RH. More specifically, the hardness is measured by pressing a type A press needle (column shape (diameter: 0.16 mm, height: 0.5 mm)) against the surface of the transfer member. The measurement value is obtained in 0.1 points from 0 to 100 points.

As described above, according to the transfer member of the present invention, the indentation depth and the hardness within the above ranges (i) allow the surface layer to follow deformation of the elastic body layer when the transfer member is pressed by an image support such as paper, thereby preventing cracks from being generated, and also (ii) make degree of freedom in deformation of the transfer member high, thereby realizing excellent transferability to uneven paper or the like too. More specifically, in the case where the hardness satisfies the above range but the indentation depth does not satisfy the above range, as shown in FIG. 1A, a surface layer 4 of a transfer member 1 deforms with a steep slope against pressure by an image support P, whereas in the case where the indentation depth also satisfies the above range as with the transfer member of the present invention, as shown in FIG. 1B, a surface layer 4 of a transfer member 1 deforms with a gentle slope against pressure by an image support P. That is, the transfer member shown in FIG. 1A has the hardness which satisfies the range defined by the present invention and therefore the deformation amount of the transfer member in the up-down direction against pressure by the image support P is the same as the deformation amount of the transfer member shown in FIG. 1B, but the transfer member shown in FIG. 1A has, as the micro-deformation amount, the indentation depth which does not satisfy the range defined by the present invention and therefore the surface layer deforms excessively. Therefore, in the present invention, a surface layer 4 follows deformation of an elastic body layer 3 and consequently cracks can be prevented from being generated, and also degree of freedom in deformation of a transfer member 1 is high and consequently excellent transferability can be obtained.

The transfer member 1 of the present invention is configured, as shown in FIG. 2, in such a way that an elastic body layer 3 is formed on a substrate 2 and a surface layer 4 is formed on the elastic body layer 3, to be more specific.

### [Substrate 2]

The substrate 2 of the transfer member 1 of the present invention is an endless belt-shaped substrate and may be constituted of a single layer or a plurality of layers.

The material for the substrate 2 is not particularly limited, and examples thereof for use include materials made of polyimide resin, polymethyl methacrylate resin, polycarbonate resin, polystyrene resin, acrylonitrile-styrene copolymer resin, polyvinylchloride resin, acetate resin, ABS resin, polyester resin and polyamide resin, preferably polyimide resin. It is preferable that the substrate 2 be formed in such a way that a conductive agent is dispersed in any of the above resins, thereby having conductivity.

The thickness of the substrate 2 is preferably 50 μm to 250 μm in terms of mechanical strength, image quality, manufacturing costs and so forth.

### [Elastic Body Layer 3]

The elastic body layer 3 of the transfer member 1 of the present invention is made of an elastic body, and examples thereof include rubber, elastomer and resin. It is preferable that the material contain chloroprene rubber in terms of durability.

The thickness of the elastic body layer 3 is preferably 200 μm to 500 μm in terms of mechanical strength, image quality, manufacturing costs and so forth.

### [Surface Layer 4]

The surface layer 4 of the transfer member 1 of the present invention preferably contains cured (meth)acrylic resin and a surface-treated metal oxide particle(s).

Cured (meth)acrylic resin is preferably one obtained by curing a curable composition containing at least the following three; polyfunctional (meth)acrylate, polyurethane acrylate and a low surface energy group-containing polymerizable component.

### [Polyfunctional (Meth)acrylate]

Polyfunctional (meth)acrylate of the curable composition has two or more (meth)acryloyloxy groups in one molecule and is used to make wear resistance, toughness and adhesiveness of the surface layer 4 of the transfer member 1 appear. Examples thereof include: bi-functional monomers such as bis(2-acryloxyethyl)-hydroxyethyl-isocyanurate, 1,6-hexanediol diacrylate, 1,4-butanediol diacrylate, 1,9-nonanediol diacrylate, neopentylglycol diacrylate, hydroxy pivalic acid neopentlyglycol diacrylate and urethane acrylate; and tri- or higher-functional monomers such as trimethylolpropane triacrylate (TMPTA), pentaerythritol triacrylate, tris(acryloxyethyl) isocyanurate, ditrimethylolpropane tetraacrylate, pentaerythritol tetraacrylate, dipentaerythritol hexaacrylate (DPHA), urethane acrylate and ester compounds synthesized with polyhydric alcohol, polybasic acid and (meth)acrylic acid, for example, an ester compound synthesized with trimethylolethane, succinic acid and acrylic acid at a mole ratio of 2:1:4. It is desired to use tri- or higher-functional acrylate in order that a coating have hard coating properties.

Polyfunctional (meth)acrylate preferably has a number average molecular weight of 3,000 or less and far preferably has a number average molecular weight of 200 or more and 1,000 or less.

The number average molecular weight of polyfunctional (meth)acrylate within the above range increases density of cured (meth)acrylic resin, and consequently high strength can be obtained.

In the present invention, the number average molecular weight of polyfunctional (meth)acrylate is a value obtained by measuring polyfunctional (meth)acrylate as a measurement sample with gel permeation chromatography.

The content of polyfunctional (meth)acrylate in the curable composition is preferably 20 to 60 percent by mass.

### [Polyurethane Acrylate]

Polyurethane acrylate of the curable composition is a polymer containing urethane bonds and containing one or more acryloyloxy groups in one molecule.

Examples thereof include one containing urethane bonds in the main chain and one or more acryloyloxy groups bound with a terminal(s) of the main chain or a side chain(s).

In the present invention, polyurethane acrylate has a function to provide the surface layer 4 with followability after the elastic body layer 3.

Polyurethane acrylate preferably has a number average molecular weight of 3,000 and more and 30,000 or less and far preferably has a number average molecular weight of 10,000 or more and 20,000 or less.

The number average molecular weight of polyurethane acrylate within the above range provides cured (meth)acrylic resin with flexibility and stretchability, and consequently strength can be prevented from decreasing.

In the present invention, the number average molecular weight of polyurethane acrylate is measured in the same way as that of polyfunctional (meth)acrylate, except that the measurement sample is changed to polyurethane acrylate.

The content of polyurethane acrylate in the curable composition is preferably 30 to 70 percent by mass.

### [Low Surface Energy Group-Containing Polymerizable Component]

In the low surface energy group-containing polymerizable component of the curable composition, the low surface energy group is a functional group having a function to reduce surface free energy of the surface layer, or a silicone-modified or fluorine-modified acrylate group to be more specific. Examples of the silicone-modified site include dimethylpolysiloxane and methylhydrogenpolysiloxane, and examples of the fluorine-modified site include polytetrafluoroethylene (PTFE) and a tetrafluoroethylene-perfluoroalkylvinylether copolymer (PFA).

The low surface energy group-containing polymerizable component is, to be more specific, a vinyl copolymer (hereinafter also referred to as the “specific vinyl copolymer”) containing one or more polyorganosiloxane chains or polyfluoroalkyl chains and three or more radical polymerizable double bonds and having a number average molecular weight of 5,000 or more and 100,000 or less.

The specific vinyl copolymer is obtained, for example, by reacting a vinyl polymer (A) with a compound (B). The vinyl polymer (A) is obtained by radical polymerization of a monomer (a) and a monomer (b), optionally with a monomer (c). The monomer (a) contains: a radical polymerizable double bond; and a polyorganosiloxane group or a polyfluoroalkyl group. The monomer (b), which is different from the monomer (a), contains a radical polymerizable double bond and a reactive functional group. The monomer (c), which is different from the monomer (a) and the monomer (b), contains a radical polymerizable double bond. The compound (B) is a compound which contains: a functional group reactive to the reactive functional group; and a radical polymerizable double bond.

The specific vinyl copolymer may be obtained by polymerization of the monomer (a) and a monomer (c′) which contains two or more radical polymerizable double bonds, optionally with the monomer (c). When the monomer (c′) is in a small amount, the expected vinyl copolymer can be obtained without gelation. Alternatively, gelation may be made harder to occur by protecting the monomer (c′) with some of the radical polymerizable double bonds being added thereto as a blocking group(s).

If the specific vinyl copolymer has a number average molecular weight of less than 5,000, crystallization easily occurs, and productivity significantly decreases, which is not preferable. If the specific vinyl copolymer has a number average molecular weight of more than 100,000, surface hardness of the surface layer to be formed decreases, and the functions as the transfer member decreases, which is not preferable.

In the present invention, the number average molecular weight of the specific vinyl copolymer is a value obtained with a gel permeation chromatography system from Shimadzu Corporation.

The monomer (a) is for reducing surface free energy of the surface layer.

Examples of the monomer (a) containing a radical polymerizable double bond and a polyorganosiloxane group include a compound represented by the following General Formula (1).

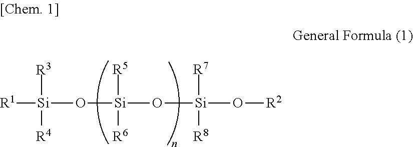

In General Formula (1), R¹ represents CH₂═CHCH₂—COO—(CH₂)m-, CH₂═C(CH₃)—COO—(CH₂)m-, CH₂═CH—(CH₂)m- or CH₂═C(CH₃)—(CH₂)m-, and m represents an integer of 0 to 10; R² represents a hydrogen atom, a methyl group or a functional group which is the same as that represented by R¹; R³, R⁴, R⁵, R⁶, R⁷ and R⁸ each represent an alkyl group or a phenyl group; and n represents a positive integer.

The hydrogen atom represented by any of R¹ to R⁸ may be substituted by a well-known substituent other than a hydrogen atom as long as the effects of the present invention are not reduced or lost.

Specific examples of the monomer (a) containing a radical polymerizable double bond and a polyorganosiloxane group include: a polyorganosiloxane compound containing a vinyl group on one terminal, such as TSL9705 from GE Toshiba Silicones Co., Ltd.; and a polyorganosiloxane compound containing a (meth)acryloxy group on one terminal, such as Silaplane FM-0711, FM-0721 and FM-0725 from CHISSO Corporation.

Examples of the monomer (a) containing a radical polymerizable double bond and a polyfluoroalkyl group include perfluoroalkylethyl acrylate.

These types of the monomer (a) may be used individually, or two or more types thereof may be mixed to use according to the required properties.

The copolymerization ratio of the monomer (a) in the vinyl polymer (A) is, based on the total mass of the monomers constituting the vinyl polymer (A), preferably 1 to 80 percent by mass, far preferably 5 to 50 percent by mass and particularly preferably 10 to 45 percent by mass in terms of surface free energy on the surface of the surface layer of the intermediate transfer belt, compatibility with the other components contained in the curable composition, adhesiveness to the elastic body layer 3, properties of the coating such as toughness, solubility of the vinyl polymer (A) in a solvent and so forth.

The monomer (b), which is different from the monomer (a) and contains a radical polymerizable double bond and a reactive functional group, is the starting point to introduce a radical polymerizable double bond to the vinyl polymer (A) which has been subjected to the first stage polymerization, and is for preventing the vinyl polymer (A) from bleeding and forming a tough partition with the introduced radical polymerizable double bond being cross-linked with active energy rays so as to be set.

Examples of the reactive functional group include a hydroxy group, a carboxyl group, an isocyanate group and an epoxy group.

Examples of the monomer (b) containing a hydroxy group include 2-hydroxyethyl(meth)acrylate, 1-hydroxypropyl(meth)acrylate, 2-hydroxypropyl(meth)acrylate, 4-hydroxybutyl(meth)acrylate, polyethylene glycol mono(meth)acrylate, polypropylene glycol mono(meth)acrylate, polytetramethylene glycol mono(meth)acrylate and hydroxystyrene.

Examples of the monomer (b) containing a carboxyl group include acrylic acid, methacrylic acid, crotonic acid, maleic acid, fumaric acid, itaconic acid and citraconic acid.

Examples of the monomer (b) containing an isocyanate group include (meth)acryloyloxyethyl isocyanate, (meth)acryloyloxypropyl isocyanate, and ones obtained by reacting hydroxyalkyl (meth)acrylate, such as 2-hydroxyethyl(meth)acrylate and 4-hydroxybutyl(meth)acrylate, with polyisocyanate, such as toluene diisocyanate and isophorone diisocyanate.

Examples of the monomer (b) containing an epoxy group include glycidyl methacrylate, glycidyl cinnamate, glycidyl allyl ether, glycidyl vinyl ether, vinylcyclohexene monoepoxide and 1,3-butadiene monoepoxide. These types of the monomer (b) may be used individually, or two or more types thereof may be mixed to use according to the required properties.

The copolymerization ratio of the monomer (b) in the vinyl polymer (A) is, based on the total mass of the monomers constituting the vinyl polymer (A), preferably 10 to 90 percent by mass, far preferably 30 to 90 percent by mass and particularly preferably 40 to 85 percent by mass in terms of abrasion resistance, hardness and surface free energy of the surface layer of the intermediate transfer belt and so forth.

The monomer (c), which is different from the monomer (a) and the monomer (b) and contains a radical polymerizable double bond, is for increasing compatibility of the vinyl polymer (A) with the other components contained in the curable composition and providing the surface layer of the intermediate transfer belt with physical properties such as hardness, toughness and abrasion resistance.

Examples of the monomer (c) include (I) (meth)acrylic acid derivative, (II) aromatic vinyl monomer, (III) olefinic hydrocarbon monomer, (IV) vinyl ester monomer, (V) vinyl halide monomer and (VI) vinyl ether monomer.

Examples of (I) (meth)acrylic acid derivative include (meth)acrylonitrile, methyl (meth)acrylate, butyl (meth)acrylate, ethylhexyl (meth)acrylate, alkyl (meth)acrylate such as stearyl (meth)acrylate, and benzyl (meth)acrylate.

Examples of (II) aromatic vinyl monomer include styrenes such as styrene, methylstyrene, ethylstyrene, chlorostyrene, monofluoromethylstyrene, difluoromethylstyrene and trifluoromethylstyrene.

Examples of (III) olefinic hydrocarbon monomer include ethylene, propylene, butadiene, isobutylene, isoprene and 1,4-pentadiene.

Examples of (IV) vinyl ester monomer include vinyl acetate.

Examples of (V) vinyl halide monomer include vinyl chloride and vinylidene chloride.

Examples of (VI) vinyl ether monomer include vinyl methyl ether.

Two or more types of these monomers may be mixed to use.

The copolymerization ratio of the monomer (c) in the vinyl polymer (A) is, based on the total mass of the monomers constituting the vinyl polymer (A), preferably 0 to 89 percent by mass in order to increase compatibility of the vinyl polymer (A) with the other components contained in the curable composition.

The vinyl polymer (A) may be synthesized with a well-known method such as solution polymerization. Examples of the solvent used in polymerization include: ketones such as acetone, methyl ethyl ketone, methyl isobutyl ketone and cyclohexanone; ethyls such as tetrahydrofuran, dioxane, ethylene glycol dimethyl ether and diethylene glycol dimethyl ether; aromatics such as benzene, toluene, xylene and cumene; and esters such as ethyl acetate and butyl acetate. Two or more types of the solvent may be mixed to use. The monomer feed ratio in polymerization is preferably 0 to 80 percent by mass.

As a polymerization initiator, a general peroxide or azo compound is used. Examples thereof include benzoyl peroxide, azoisobutylvaleronitrile, azobisisobutyronitrile, di-t-butyl peroxide, t-butyl perbenzoate, t-butyl peroctoate and cumene hydroxy peroxide. The polymerization temperature is preferably 50° C. to 140° C. and far preferably 70° C. to 140° C.

The number average molecular weight of the obtained vinyl polymer (A) is preferably 5,000 to 100,000.

The thus-obtained vinyl polymer (A) containing a reactive functional group and a polyorganosiloxane chain or a polyfluoroalkyl chain is reacted with the compound (B) containing a functional group reactive to the reactive functional group and a radical polymerizable double bond, whereby the specific vinyl copolymer containing radical polymerizable double bonds and a polyorganosiloxane chain(s) or a polyfluoroalkyl chain(s) is obtained.

It is preferable that the vinyl polymer (A) and the compound (B) be reacted at the ratio of the number of functional groups of the compound (B) reactive to reactive functional groups of the vinyl polymer (A) to the number of the reactive functional groups of the vinyl polymer (A) being 100%, but the ratio may be less than 100% as long as photoreactivity is not reduced.

As a combination of the reactive functional group and the functional group reactive to the reactive functional group, various well-known combinations described below can be adopted, and also as a reaction method thereof, various well-known reaction methods described below can be adopted.

1) Where the reactive functional group is a hydroxy group, representative examples of the functional group reactive to the reactive functional group include an acid halogen group and an isocyanate group. More specifically, a hydroxy group reacts with (meth)acrylic acid chloride or methacryloxyethyl isocyanate, so that a radical polymerizable double bond is introduced. The hydroxy group reacts with (meth)acrylic acid chloride as follows; a catalyst is added to a solution of a polymer containing a polyorganosiloxane chain or a polyfluoroalkyl chain and a hydroxy group, (meth)acrylic acid chloride is added thereto, and heating is carried out. Examples of a solvent for use include solutions of: ketones such as 2-butanone, methyl isobutyl ketone and cyclohexanone; esters such as ethyl acetate, propyl acetate and butyl acetate; and ethers such as ethylene glycol dimethyl ether and dioxolane. Preferable examples of the catalyst include triethylamine and dimethylbenzylamine. The amount of the catalyst to the solid content is 0.1 percent by mass to 1 percent by mass. The reaction is carried out under air to prevent gelation. The reaction temperature is 80° C. to 120° C., and the reaction time is 1 hour to 24 hours.

The hydroxy group reacts with methacryloxyethyl isocyanate as follows; as a catalyst, a metal compound, such as tin octylate, dibutyltin dilaurate or zinc octylate, or a tertiary amine, such as triethylamine, tributylamine or dimethylbenzylamine, is added to a solution of a polymer containing a polyorganosiloxane chain or a polyfluoroalkyl chain and a hydroxy group at 0.05 PHR (Per Hundred Resin) to 1 PHR, and methacryloxyethyl isocyanate is added thereto under heating. Examples of a solvent for use include solutions of: ketones such as 2-butanone, methyl isobutyl ketone and cyclohexanone; esters such as ethyl acetate, propyl acetate and butyl acetate; and ethers such as ethylene glycol dimethyl ether and dioxolane.

2) Where the reactive functional group is an epoxy group, representative examples of the functional group reactive to the reactive functional group include a carboxyl group. More specifically, an epoxy group reacts with (meth)acrylic acid, so that a radical polymerizable double bond is introduced. The epoxy group reacts with (meth)acrylic acid as follows; a catalyst is added to a solution of a polymer containing a polyorganosiloxane chain or a polyfluoroalkyl chain and an epoxy group, (meth)acrylic acid is added thereto, and heating is carried out. The reaction conditions to be suggested are the same as those in the case of 1) where the reactive functional group is a hydroxy group, but as the catalyst, a tertiary amine is the most preferable. Examples of the compound containing a carboxyl group and a radical polymerizable double bond include, other than (meth)acrylic acid, pentaerythritol triacrylate succinic anhydride adduct and (meth)acryloxyethyl phthalate.

3) Where the reactive functional group is an isocyanate group, representative examples of the functional group reactive to the reactive functional group include a hydroxy group, and examples thereof include hydroxyethyl (meth)acrylate, hydroxypropyl (meth)acrylate, hydroxybutyl (meth)acrylate and ε-caprolactone adduct of hydroxyethyl (meth)acrylate. The reaction conditions are preferably the same as those in the case of 1) where the reactive functional group is a hydroxy group.

Based on the total mass of the nonvolatile matters of the curable composition, the content of the monomer (a) containing a polyorganosiloxane group or a polyfluoroalkyl group may be 0.01 to 10 percent by mass. The specific vinyl copolymer containing one or more polyorganosiloxane chains or polyfluoroalkyl chains and three or more radical polymerizable double bonds and having a number average molecular weight of 5,000 or more and 100,000 or less has a property to be concentrated on the surface of the elastic body layer 3 when the curable composition is applied to the elastic body layer 3. Consequently, even when the monomer (a) is in a small amount, sufficiently low surface free energy can be generated.

Examples of the specific vinyl copolymer containing one or more polyorganosiloxane chains or polyfluoroalkyl chains and three or more radical polymerizable double bonds and having a number average molecular weight of 5,000 or more and 100,000 or less as the low surface energy group-containing polymerizable component include commercially available “MEGAFACE” (from DIC Corporation) and “FulShade” (from TOYO INK Co., Ltd.).

The content of the low surface energy group-containing polymerizable component in the curable composition is preferably 5 to 40 percent by mass.

In cured (meth)acrylic resin obtained by curing the curable composition described above, it is preferable that the content of a structural unit(s) derived from polyfunctional (meth)acrylate be 20 to 60 percent by mass, the content of a structural unit (s) derived from polyurethane acrylate be 30 to 70 percent by mass, and the content of a structural unit(s) derived from the low surface energy group-containing polymerizable component be 5 to 40 percent by mass.

### [Metal Oxide Particle]

The surface layer 4 of the transfer member 1 of the present invention preferably contains the surface-treated metal oxide particle. The metal oxide particle contained in the surface layer 4 allows the surface layer 4 to have toughness and high durability.

The metal oxide particle is obtained by carrying out surface treatment with a surface treatment agent on an untreated metal oxide particle(s).

The untreated metal oxide particle used for the present invention may be oxide of any metal including transition metal. Examples thereof include silica (silicon oxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide and vanadium oxide. Among these, for example, titanium oxide, alumina, zinc oxide and tin oxide are preferable, in particular, alumina and tin oxide.

The untreated metal oxide particle to use is manufactured with a well-known method. Examples thereof include a gas phase method, a chlorine method, a sulfuric acid method, a plasma method and an electrolytic method.

The untreated metal oxide particle preferably has a number average primary particle size of 1 nm or more and 300 nm or less, in particular, 3 nm or more and 100 nm or less. If the particle size is small, wear resistance may be unsufficient, whereas if the particle size is large, writing light may be scattered, and also the particle may impede light curing and make wear resistance unsufficient.

The number average primary particle size of the untreated metal oxide particle is a value obtained as follows; 10,000-fold enlarged pictures are taken with a scanning electron microscope (from JEOL Ltd.), picture images of 300 particles (no aggregated particle included) scanned with a scanner at random are processed/analyzed with an automatic image processor LUZEX AP (from Nireco Corporation) with software Ver. 1.32 so that the number average primary particle size is calculated therefrom.

Examples of the surface treatment agent used for the surface treatment of the untreated metal oxide particle include a radical polymerizable functional group-containing compound, and examples of the radical polymerizable functional group include an acryloyl group and a methacryloyl group.

Further, silicone oil, a polyfluoroalkyl group-containing compound or the like may also be used as the surface treatment agent in order to provide a low surface energy property. Examples of the silicone oil for use include straight silicone oil (methylhydrogenpolysiloxane (MHP), etc.) and modified silicone oil (modified silicone oil with carbinol on one terminal, modified silicone oil with diol on one terminal, etc.).

In the present invention, the metal oxide particle preferably has the surface to which at least one of the radical polymerizable functional group and the low surface energy functional group is introduced. The low surface energy functional group is a functional group introduced with the surface treatment agent used to provide the low surface energy property, and examples thereof include a silicone oil group and a polyfluoroalkyl group each of which is silane-coupled. In the case where both of them are introduced, the ratio of the radical polymerizable functional group to the low surface energy functional group is preferably 2:1 to 1:2.

The radical polymerizable functional group-containing surface treatment agent used for the surface treatment of the untreated metal oxide particle is preferably a compound containing, in the same molecule, (i) a functional group containing a carbon-carbon double bond and (ii) a polar group, such as an alkoxy group, which is coupled with the hydroxy group on the surface of the untreated metal oxide particle.

The radical polymerizable functional group-containing surface treatment agent is far preferably a compound containing a functional group polymerized (cured) by irradiation with active energy rays such as ultraviolet rays or electron rays, thereby being resin such as polystyrene or polyacrylate. In particular, a reactive acryloyl or methacryloyl group-containing silane compound is preferable because of its curability with a small amount of light and/or in a short time.

Examples of the radical polymerizable functional group-containing surface treatment agent include a compound represented by the following General Formula (2).

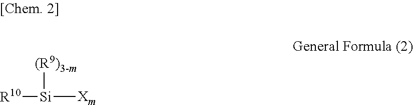

In General Formula (2), R⁹ represents a hydrogen atom, a C₁-C₁₀ alkyl group or a C₁-C₁₀ aralkyl group; R¹⁰ represents an organic group containing a reactive double bond; X represents a halogen atom, an alkoxy group, an acyloxy group, an aminoxy group or a phenoxy group; and m represents an integer of 1 to 3.

Examples of the compound represented by General Formula (2) include the following S-1 to S-30.
S-1 CH₂═CHSi(CH₃)(OCH₃)₂
S-2 CH₂═CHSi(OCH₃)₃
S-3 CH₂═CHSiCl₃
S-4 CH₂═CHCOO(CH₂)₂Si(CH₃)(OCH₃)₂
S-5 CH₂═CHCOO(CH₂)₂Si(OCH₃)₃
S-6 CH₂═CHCOO(CH₂)₂Si(OC₂H₅)(OCH₃)₂
S-7 CH₂═CHCOO(CH₂)₃Si(OCH₃)₃
S-8 CH₂═CHCOO(CH₂)₂Si(CH₃)Cl₂
S-9 CH₂═CHCOO(CH₂)₂SiCl₃
S-10 CH₂═CHCOO(CH₂)₃Si(CH₃)Cl₂
S-11 CH₂═CHCOO(CH₂)₃SiCl₃
S-12 CH₂═C(CH₃)COO(CH₂)₂Si(CH₃)(OCH₃)₂
S-13 CH₂═C(CH₃)COO(CH₂)₂Si(OCH₃)₃
S-14 CH₂═C(CH₃)COO(CH₂)₃Si(CH₃)(OCH₃)₂
S-15 CH₂═C(CH₃)COO(CH₂)₃Si(OCH₃)₃
S-16 CH₂═C(CH₃)COO(CH₂)₂Si(CH₃)Cl₂
S-17 CH₂═C(CH₃)COO(CH₂)₂SiCl₃
S-18 CH₂═C(CH₃)COO(CH₂)₃Si(CH₃)Cl₂
S-19 CH₂═C(CH₃)COO(CH₂)₃SiCl₃
S-20 CH₂═CHSi(C₂H₅)(OCH₃)₂
S-21 CH₂═C(CH₃)Si(OCH₃)₃
S-22 CH₂═C(CH₃)Si(OC₂H₅)₃
S-23 CH₂═CHSi(OCH₃)₃
S-24 CH₂═C(CH₃)Si(CH₃)(OCH₃)₂
S-25 CH₂═CHSi(CH₃)Cl₂
S-26 CH₂═CHCOOSi(OCH₃)₃
S-27 CH₂═CHCOOSi(OC₂H₅)₃
S-28 CH₂═C(CH₃)COOSi(OCH₃)₃
S-29 CH₂═C(CH₃)COOSi(OC₂H₅)₃
S-30 CH₂═C(CH₃)COO(CH₂)₃Si(OC₂H₅)₃

Other than the compound represented by General Formula (2), the following S-31 to S-33 may be used as the radical polymerizable functional group-containing compound.

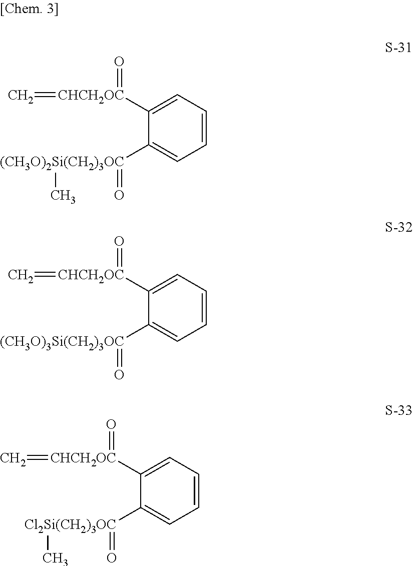

These types of the compound may be used individually, or two or more types thereof may be mixed to use.

Further, as the surface treatment agent, epoxy-based compounds represented by the following S-35 to S-37 may also be used.

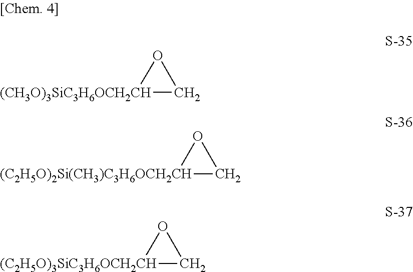

The surface treatment may be carried out, for example, using a wet media dispersion-type apparatus with 0.1 to 200 parts by mass of a surface treatment agent and 50 to 5000 parts by mass of a solvent to 100 parts by mass of the untreated metal oxide particle.

Wet dispersion of slurry (suspension of solid particles) containing the untreated metal oxide particle and the surface treatment agent disaggregates aggregates of the untreated metal oxide particle while surface-treating the untreated metal oxide particle. Thereafter, the solvent is removed, and pulverization is carried out. Consequently, the uniform-and-finer metal oxide particle surface-treated with the surface treatment agent can be obtained.

The surface treating amount (coating amount) of the surface treatment agent is, to the untreated metal oxide particle, preferably 0.1 percent by mass or more and 60 percent by mass or less, in particular, 5 percent by mass or more and 40 percent by mass or less.

The surface treating amount of the surface treatment agent is obtained as follows; the surface-treated metal oxide particle is heated at 550° C. for 3 hours, the ignition residue is subjected to quantitative analysis with fluorescent X-rays, and Si amount is converted into molecular weight.

The wet media dispersion-type apparatus is an apparatus which, with a container filled with beads as media, pulverizes and disperses aggregated particles of metal oxide particles by rotating at high speed a stirring disc perpendicularly attached to a rotation axis. The configuration thereof may be any as long as the apparatus can sufficiently disperse untreated metal oxide particles for surface treatment on the untreated metal oxide particles and carry out the surface treatment, and hence there are various adoptable modes, for example, a longitudinally-mounted type, a transversely-mounted type, a continuous system and a batch system, or to be more specific, a sand mill, an ultra visco mill, a pearl mill, a glen mill, a dyno mill, an agitator mill and a dynamic mill. These dispersion-type apparatuses finely pulverize and disperse metal oxide particles with pulverization media such as balls and beads by impact/pressure crushing, friction, shearing, shear stress or the like. Examples of the beads used in the dispersion-type apparatus include balls made of, as the raw material, glass, alumina, zircon, zirconia, steel and flint, preferably zirconia and zircon. In general, beads having a diameter of about 1 mm to 2 mm are used, but, in the present invention, beads having a diameter of about 0.3 mm to 1.0 mm are preferably used.

For the disc and the inner wall of the container used in the wet media dispersion-type apparatus, various materials such as stainless steel, nylon and ceramic can be used. In the present invention, it is particularly preferable that the disc and the inner wall of the container be made of ceramic such as zirconia or silicon carbide.

With the wet dispersion process described above, the metal oxide particle surface-treated with the surface treatment agent is obtained.

The content of the above-described metal oxide particle in the surface layer is preferably 4 to 40 percent by volume to the curable composition.

### [Other Additives]

The surface layer may contain, as needed, additive components such as an organic solvent, a photostabilizer, an ultraviolet absorber, a catalyst, a colorant, an antistat, a lubricant, a leveling agent, an antifoamer, a polymerization promoter, an antioxidant, a flame retardant, an infrared light absorber, a surfactant and a surface modifier.

The organic solvent is blended in the curable composition for use in terms of uniform solubility and dispersion stability of the curable composition, adhesiveness to the endless belt-shaped substrate, and smoothness and uniformity of the coating. The organic solvent is not particularly limited as long as it satisfies the above properties. Examples thereof include organic solvents of alcohols, hydrocarbons, halogenated hydrocarbons, ethers, ketones, esters and polyhydric alcohol derivatives.

The thickness of the surface layer 4 is preferably 1 μm to 5 μm in terms of mechanical strength, image quality, manufacturing costs and so forth.

### [Method for Manufacturing Transfer Member]

A method for manufacturing the transfer member of the present invention includes steps of, for example: applying an elastic body layer-forming application liquid for forming an elastic body layer onto a substrate so as to form a coating, drying the coating so as to form an elastic body layer, applying a surface layer-forming application liquid for forming a surface layer onto the elastic body layer so as to forma coating, and irradiating and curing the coating with active energy rays so as to form a surface layer.

The substrate may be produced with an appropriate well-known method. For example, in the case where polyimide resin is used as the material for the substrate, a polyamic acid solution is spread in a ring shape, for example, by immersing the outer circumferential face of a cylindrical metal mold in the solution, by applying the solution to the inner circumferential face thereof, by centrifuging the solution or by filing an injection mold with the solution; the spread layer is dried and molded in a belt shape; the molded product is heated so as to invert polyamic acid into imide; and the resulting product is collected from the mold. (Refer to, for example, Japanese Patent Application Laid-Open Publication Nos. 61-95361, 64-22514 and 3-180309.) In producing the endless belt-shaped substrate, processes such as mold releasing and degassing may be carried out appropriately.

The elastic body layer-forming application liquid is prepared, for example, by adding the material for forming the elastic body layer to a solvent in such a way that the solid content concentration becomes 20 to 30 percent by mass.

The elastic body layer-forming application liquid is applied, for example, by spiral spray application using a nozzle.

The surface layer-forming application liquid contains: a curable composition containing at least the following three, polyfunctional (meth)acrylate, polyurethane acrylate and low surface energy group-containing polymerizable component; a surface-treated metal oxide particle(s); and a polymerization initiator, optionally with other components such as a solvent.

The surface layer-forming application liquid is prepared, for example, by adding the curable composition and the surface-treated metal oxide particle to a solvent in such away that the solid content concentration becomes 3 to 10 percent by mass and dispersing the resulting product, for example, with a wet media dispersion-type apparatus. As the wet media dispersion-type apparatus, there are various adoptable modes, for example, a longitudinally-mounted type, a transversely-mounted type, a continuous system and a batch system, or to be more specific, a sand mill, an ultra visco mill, a pearl mill, a glen mill, a dyno mill, an agitator mill and a dynamic mill. These dispersion-type apparatuses finely pulverize and disperse metal oxide particles with pulverization media such as balls and beads by impact/pressure crushing, friction, shearing, shear stress or the like.

Examples of the beads used in the dispersion-type apparatus include balls made of, as the raw material, glass, alumina, zircon, zirconia, steel and flint, preferably zirconia and zircon. In general, beads having a diameter of about 1 mm to 2 mm are used, but, in the present invention, beads having a diameter of about 0.3 mm to 1.0 mm are preferably used.

For the disc and the inner wall of the container used in the wet media dispersion-type apparatus, various materials such as stainless steel, nylon and ceramic can be used. In the present invention, it is particularly preferable that the disc and the inner wall of the container be made of ceramic such as zirconia or silicon carbide.

It is preferable that the end of the dispersion be a dispersion state in which the change ratio of light transmittance at 405 nm when natural drying of the dispersion liquid applied onto a PET film with a wire bar finishes to light transmittance thereat 1 hour earlier is 3% or less, in particular, 1% or less.

With the wet dispersion process described above, the surface layer-forming application liquid is obtained.

The polymerization initiator contained in the surface layer-forming application liquid is not particularly limited as long as it polymerizes the curable composition with active energy rays of light or the like.

Examples of the polymerization initiator include photoinitiators of an acetophenone-based compound, a benzoin ether-based compound, a benzophenone-based compound, a sulfur compound, an azo compound, a peroxide compound and a phosphine oxide-based compound.

Specific examples thereof include: carbonyl compounds such as benzoin, benzoin methyl ether, benzoin ethyl ether, benzoin isopropyl ether, acetoin, butyroin, toluoin, benzil, benzophenone, p-methoxybenzophenone, diethoxyacetophenone, α,α-dimethoxy-α-phenylacetophenone, methyl phenyl glyoxylate, ethyl phenyl glyoxylate, 4,4′-bis(dimethylaminobenzophenone), 2-hydroxy-2-methyl-1-phenylpropan-1-one, 2,2-dimethoxy-1,2-diphenylethan-1-one, 1-hydroxycyclohexylphenylketone; sulfur compounds such as tetramethyl thiuram monosulfide and tetramethyl thiuram disulfide; azo compounds such as azobisisobutyronitrile and azobis-2,4-dimethylvalero; and peroxide compounds such as benzoyl peroxide and di-t-butyl peroxide. These may be used individually, or two or more types thereof may be mixed to use.

Of these, in order to have light stability, high efficiency of photofragmentation, surface curability, compatibility with cured (meth)acrylic resin, low volatility and little odor, preferably used examples include 1-hydroxycyclohexylphenylketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzil]-phenyl}-2-methyl-propan-1-one, 2,4,6-trimethylbenzoyl-diphenyl-phosphineoxide, bis(2,4,6-trimethylbenzoyl)-phenyl-phosphineoxide, 2-methyl-1-[4-(methylthio)phenyl]-2-morpholinopropane-1-one and 1-[4-(2-hydroxyethoxy)-phenyl]-2-hydroxy-2-methyl-1-propan-1-one.

The content of the polymerization initiator in the surface layer-forming application liquid is preferably 1 to 10 percent by mass, and, in order to have excellent curability and also have high adhesiveness to the elastic body layer as well as sufficient hardness, far preferably 2 to 8 percent by mass and particularly preferably 3 to 6 percent by mass.

The surface layer-forming application liquid preferably contains a solvent because it makes applicability (workability) excellent.

Examples of the solvent include ethanol, isopropanol, butanol, toluene, xylene, acetone, methyl ethyl ketone, ethyl acetate, butyl acetate, ethylene glycol diethyl ether and propylene glycol monomethyl ether acetate.

To the surface layer-forming application liquid, other components such as a photosensitizer may be added as needed.

The viscosity of the surface layer-forming application liquid is preferably 10 cP to 100 cP.

The solid content concentration of the surface layer-forming application liquid is preferably 3 to 10 percent by mass. In the surface layer-forming application liquid, the metal oxide particle, polyfunctional (meth)acrylate, polyurethane acrylate and low surface energy group-containing polymerizable component are the solid content.

The surface layer-forming application liquid is applied, for example, by immersion application or spray application.

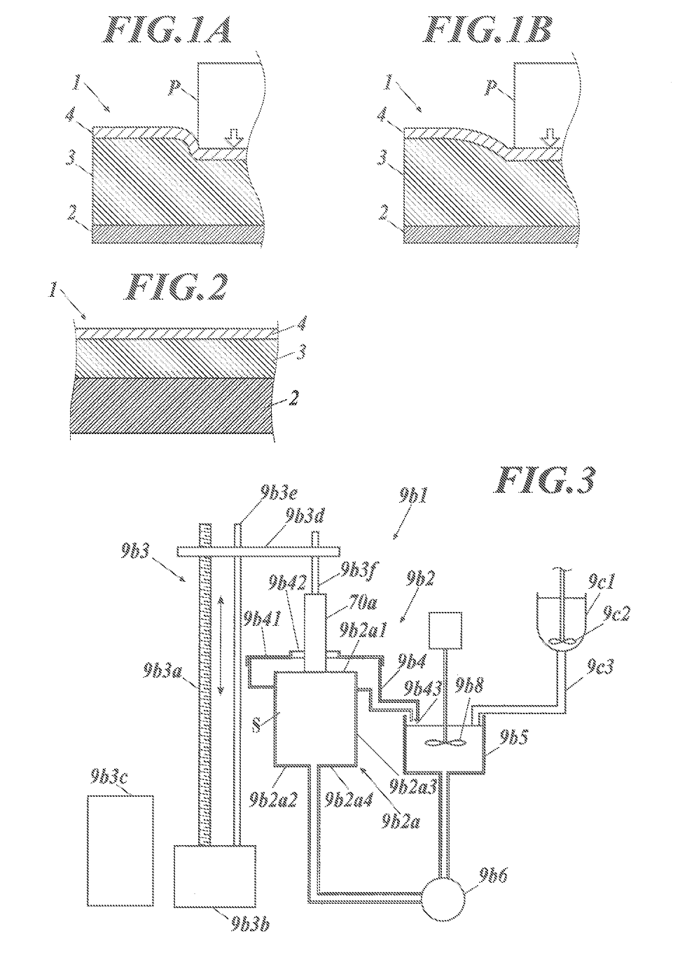

As an apparatus to apply the surface layer-forming application liquid by immersion application, for example, an application apparatus shown in FIG. 3 is used.

An immersion application apparatus 9b1 includes an application section 9b2 and a supply section 9b3 to supply a treatment target. The application section 9b2 includes an application tub 9b2a, an overflow liquid receiving tub 9b4, an application liquid supply tank 9b5 and a liquid sending pump 9b6. The overflow liquid receiving tub 9b4 is disposed on the upper side of the application tub 9b2a so as to receive the surface layer-forming application liquid overflowing from an open part 9b2a1 of the application tub 9b2a as an overflow liquid.

S represents the surface layer-forming application liquid, 9c1 represents a container for preparing the surface layer-forming application liquid, 9c2 represents a stirrer, and 9c3 represents a liquid sending pipe.

The application tub 9b2a includes a bottom part 9b2a2 and a side wall 9b2a3 standing from the circumference of the bottom part 9b2a2, and the upper part of the application tub 9b2a forms the open part 9b2a1. The application tub 9b2a is cylindrical. The diameter of the open part 9b2a1 is the same as the diameter of the bottom part 9b2a2. 9b2a4 represents an application liquid supply port provided at the bottom part 9b2a2 of the application tub 9b2a. The surface layer-forming application liquid S is sent by the liquid sending pump 9b6 to the application tub 9b2a through the application liquid supply port 9b2a4.

9b41 represents a cover of the overflow liquid receiving tub 9b4. The cover 9b41 has a hole 9b42 at the center thereof. 9b43 represents an application liquid returning port to return the surface layer-forming application liquid S from the overflow liquid receiving tub 9b4 to the application liquid supply tank 9b5. 9b8 represents a fan for stirring disposed in the application liquid supply tank 9b5.

The supply section 9b3 includes a ball screw 9b3a, a drive section 9b3b which rotates the ball screw 9b3a, a control section 9b3c which controls the rotation speed of the ball screw 9b3a, an elevation member 9b3d engaged with the ball screw 9b3a, and a guiding member 9b3e which moves the elevation member 9b3d in the up-down direction (indicated with arrows in FIG. 3) as the ball screw 9b3a rotates. 9b3f represents a holding member attached to the elevation member 9b3d for holding a treatment target 70a. The holding member 9b3f is attached to the elevation member 9b3d in such a way that the held treatment target 70a is located at approximately the center of the application tub 9b2a.

The treatment target 70a is held by the holding member 9b3f attached to the elevation member 9b3d. As the ball screw 9b3a of an intermediate belt rotates, the elevation member 9b3d moves in the up-down direction. Thereby, the treatment target 70a held by the holding member 9b3f is immersed in the surface layer-forming application liquid S in the application tub 9b2a and then pulled out. Thus, the surface layer-forming application liquid S is applied to the surface of the treatment target 70a, whereby a coating is formed.

The speed to pull out the treatment target 70a needs to be appropriately changed according to the viscosity of the surface layer-forming application liquid S to be used. For example, in the case where the viscosity of the surface layer-forming application liquid S is 10 to 200 mPa·s, the speed to pull out the treatment target 70a is preferably 0.5 to 15 mm/sec in terms of application uniformity, thickness of the coating, drying and so forth.

The curable composition is cured, for example, by irradiation with active energy rays.

The active energy rays are not particularly limited as long as they are of an energy source which activates the curable composition. Examples thereof include ultraviolet rays, electron rays and gamma rays, and among these, ultraviolet rays and electron rays are preferable. In particular, ultraviolet rays are preferable because they are easy to handle and easily generate high energy. Any light source can be used as a light source for ultraviolet rays as long as it generates ultraviolet rays. Examples thereof for use include a low-pressure mercury lamp, a medium-pressure mercury lamp, a high-pressure mercury lamp, an ultrahigh-pressure mercury lamp, a carbon arc lamp, a metal halide lamp and a xenon lamp. Further, an ArF eximer laser, a KrF eximer layer, an eximer lamp, synchrotron radiation and so forth may also be used. To emit the active energy rays in a spot shape, an ultraviolet laser is preferably used.

The electron rays can be used in the same way. The electron rays are, for example, electron rays having an energy of 50 keV to 1000 keV, preferably 100 keV to 300 keV, emitted from various electron beam accelerators such as a Cockroft-Walton accelerator, a Van de Graaff accelerator, a resonance transformer accelerator, an isolated core transformer accelerator, a linear accelerator, a dynamitron accelerator and a radio frequency accelerator.

The irradiation conditions differ depending on the light sources, but the irradiation light amount is preferably 5 J/cm² or more, far preferably 7 to 20 J/cm² and particularly preferably 10 to 12 J/cm² in terms of curing uniformity, hardness, curing time, curing speed and so forth.

The irradiation light amount is a value obtained with UIT250 (from USHIO Inc.).

The irradiation time with active energy rays is preferably 10 seconds to 8 minutes, and, in terms of curing efficiency, working efficiency and so forth, far preferably 30 seconds to 5 minutes.

The atmosphere for irradiation with active energy rays is air atmosphere under which curing can be carried out without any problem. However, in terms of curing uniformity, curing time and so forth, it is preferable that the oxygen concentration in the atmosphere be 5% or less, in particular, 1% or less. In order to create this atmosphere, introduction of a nitrogen gas is effective.

The oxygen concentration is a value obtained with an ambient gas monitoring oxygen analyzer “OX100” (from Yokogawa Electric Corporation).

It is preferable that drying be carried out after the surface layer-forming application liquid is applied onto the elastic body layer. Thereby, the solvent is removed.

The coating may be dried before, after and/or during polymerization of the polymerizable components as selected. However, it is preferable that primary drying be carried out on the coating to the extent that fluidity of the coating is lost, the polymerizable components be polymerized, and then secondary drying be carried out to adjust the amount of the volatile matters in the surface layer to a predetermined amount.

The coating can be dried with an appropriately-selected method according to the type of the solvent to be used, the thickness of the surface layer to be formed and so forth. The drying temperature is preferably 60° C. to 120° C. and far preferably 80° C. to 100° C. The drying time is preferably 1 minute to 10 minutes and far preferably about 5 minutes.

### [Image Forming Apparatus]

The above-described transfer member is suitably used as an intermediate transfer belt in various well-known electrophotographic image forming apparatuses such as monochrome image forming apparatuses and full-color image forming apparatuses.

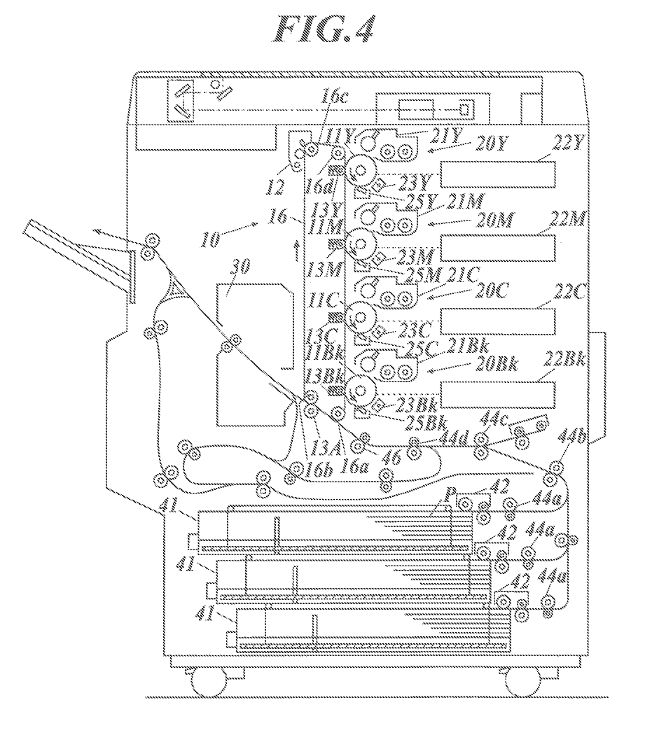

FIG. 4 is a cross sectional view showing an example of the configuration of an image forming apparatus provided with the transfer member of the present invention.

The image forming apparatus includes: image forming units 20Y, 20M, 20C and 20Bk; an intermediate transfer section 10 which transfers, onto an image support P, toner images formed by the image forming units 20Y, 20M, 20C and 20Bk; and a fixing device 30 which fixes the toner images to the image support P by heating and pressurizing the image support P so as to form a toner layer.

The image forming unit 20Y forms yellow toner images, the image forming unit 20M forms magenta toner images, the image forming unit 20C forms cyan toner images, and the image forming unit 20Bk forms black toner images.

The image forming units 20Y, 20M, 20C and 20Bk respectively include: photosensitive bodies 11Y, 11M, 11C and 11Bk as electrostatic latent image holders; chargers 23Y, 23M, 23C and 23Bk which uniformly apply electric potentials to the surfaces of the photosensitive bodies 11Y, 11M, 11C and 11Bk; exposure devices 22Y, 22M, 22C and 22Bk which form electrostatic latent images in desired shapes on the uniformly-charged photosensitive bodies 11Y, 11M, 11C and 11Bk; developing devices 21Y, 21M, 21C and 21Bk which develop the electrostatic latent images by carrying chromatic toners onto the photosensitive bodies 11Y, 11M, 11C and 11Bk; and cleaners 25Y, 25M, 25C and 25Bk which collect the remaining toners remaining on the photosensitive bodies 11Y, 11M, 11C and 11Bk after primary transfer.

The intermediate transfer section 10 includes: an intermediate transfer belt 16 which circularly moves; primary transfer rollers 13Y, 13M, 13C and 13Bk as a primary transfer section which transfers the chromatic toner images formed by the image forming units 20Y, 20M, 20C and 20Bk to the intermediate transfer belt 16; a secondary transfer roller 13A as a secondary transfer section which transfers, onto an image support P, the chromatic toner images (a color image) transferred onto the intermediate transfer belt 16 by the primary transfer rollers 13Y, 13M, 13C and 13Bk; and a cleaner 12 which collects the remaining toners remaining on the intermediate transfer belt 16.

As the intermediate transfer belt 16, the transfer member of the present invention is used.

The intermediate transfer belt 16 is endless belt-shaped, and is stretched around support rollers 16a to 16d and supported thereby in such a way as to be rotatable.

The intermediate transfer belt 16 has a structure in which the specific surface layer containing the cured (meth)acrylic resin and the metal oxide particle is formed on the outer circumferential face of an elastic body layer on a substrate.

The toner images of the respective colors formed by the image forming units 20Y, 20M, 20C and 20Bk are successively transferred onto the rotating endless intermediate transfer belt 16 by the primary transfer rollers 13Y, 13M, 13C and 13Bk so as to form a color image constituted of the toner images of the colors being superposed. An image support P housed in a paper feed cassette 41 is fed by a paper feed/carry section 42 so as to be carried to the secondary transfer roller 13A as the secondary transfer section through intermediate rollers 44a to 44d and a resist roller 46, and the color image is transferred onto the image support P by the secondary transfer roller 13A.

The image support P having the color image transferred thereonto is fixed by the fixing device 30 with a heat-roller fixing unit installed therein, and held by and sandwiched between paper ejection rollers so as to be placed on a paper ejection tray attached to the outside of the image forming apparatus.

Meanwhile, the remaining toners on the endless intermediate transfer belt 16 are removed by the cleaner 12 after the endless intermediate transfer belt 16 transfers the color image onto the image support P with the secondary transfer roller 13A and performs self stripping to release the image support P.

The above-described image forming apparatus has the intermediate transfer belt constituted of the transfer member of the present invention, and therefore the intermediate transfer belt has both high durability and excellent transfer functions. Consequently, the image forming apparatus can form high-quality images for a long time.

### [Developer]

Developer used in the image forming apparatus of the present invention may be one-component developer of magnetic or nonmagnetic toner or may be two-component developer of toner and carriers mixed.

The toner constituting the developer is not particularly limited, and hence various well-known toners can be used. However, it is preferable to use, for example, what is called, polymerized toner, which is obtained by polymerization, having a volume-based median size of 3 μm to 9 μm. Use of the polymerized toner realizes high resolving power and stable image density of formed images and hardly causes image fogging.

The carriers constituting the two-component developer are not particularly limited, and hence various well-known carriers can be used. However, it is preferable to use, for example, ferrite carriers constituted of magnetic particles having a volume-based median size of 30 μm to 65 μm and a magnetization amount of 20 emu/g to 70 emu/g. If carriers having a volume-based median size of less than 30 μm are used, carrier adhesion may occur and a void image may be generated, whereas if carriers having a volume-based median size of more than 65 μm are used, an image having non-uniform density may be generated.

### [Image Support]

Examples of the image support P used in the image forming apparatus of the present invention include but are not limited to plain paper from thin paper to thick paper, high-quality paper, coated printing paper such as art paper and coated paper, commercially-available Japanese paper and post cards, plastic films for OHP and cloth.

The transfer member of the present invention is an endless belt-shaped transfer member constituted of an elastic body layer and a surface layer formed on the elastic body layer and having an indentation depth and a hardness of specific ranges, which ensures the surface layer followability after the elastic body layer. Consequently, the transfer member can have such high durability that the surface layer neither separates from the elastic body layer nor gets damaged, and also can have excellent transfer functions. Further, the image forming apparatus of the present invention is provided with the above-described transfer member. Consequently, the image forming apparatus can stably form high-quality images for a long time.

### Examples

### Transfer Member Manufacturing Example 1

### (1) Production of Endless Belt-Shaped Substrate

Dried oxidized carbon black “SPECIAL BLACK 4” (from Degussa, pH3.0, volatile content: 14.0%) was added to, as a polyamic acid solution, an N-methyl-2-pyrrolidone (NMP) solution “U-Varnish S (solid content: 18 percent by mass)” (from Ube Industries, Ltd.) constituted of 3 3′ 4 4′-biphenyltetracarboxylic dianhydride (BPDA) and p-phenylenediamine (PDA) in such a way as to be 23 parts by mass to 100 parts by mass of the solid content of polyimide resin. Using a collision type disperser “GeanusPY” (from Geanus), the resulting product was made to pass through a path five times, the path through which, with a pressure of 200 MPa and a minimum area of 1.4 mm², the product was split into two and these two collided with each other so that each of these two was split into two again, and the resulting products were mixed. Thus, a polyamic acid solution containing carbon black was obtained.

The polyamic acid solution containing carbon black was applied to the inner circumferential face of a cylindrical metal mold through a dispenser so as to be 0.5 mm thick, and rotation was carried out at 1,500 rpm for 15 minutes so as to form a spread layer having a uniform thickness. Thereafter, the outside of the metal mold was exposed to a hot wind of 60° C. for 30 minutes while rotation was carried out at 250 rpm. Thereafter, heating was carried out at 150° C. for 60 minutes. Thereafter, the temperature was raised to 360° C. at a temperature increase rate of 2° C./min, and heating was further carried out at 360° C. for 30 minutes so as to remove the solvent, remove the cyclodehydration liquid and complete the imide inversion reaction. Thereafter, the temperature was returned to room temperature, and the resulting product was released from the cylindrical metal mold. Thus, an endless belt-shaped substrate 1 having a thickness of 0.1 mm was produced.

### (2) Formation of Elastic Body Layer

To 100 parts by mass of chloroprene rubber S-40A (from DENKI KAGAKU KOGYO KABUSHIKI KAISHA), 40 parts by mass of furnace black (from ASAHI CARBON Co., Ltd.), 40 parts by mass of aluminum hydroxide, 20 parts by mass of silica, 10 parts by mass of talc, 4 parts by mass of magnesium oxide as a vulcanizer, 5 parts by mass of zinc oxide as a vulcanizer and 1 part by mass of ethylenethiourea as a vulcanization accelerator were mixed together with 2 parts by mass of process oil. Thus, an elastic body material 1 was obtained. The elastic body material 1 was dissolved and dispersed in a solvent of toluene in such a way that the solid content concentration became 20 percent by mass. Thus, an elastic body layer-forming application liquid 1 was prepared.

Onto the endless belt-shaped substrate 1, the elastic body layer-forming application liquid 1 was applied by spiral spray application using a nozzle. Thus, an elastic body layer 1 having a dry thickness of 300 μm was formed.

### (3) Formation of Surface Layer

### (3-1) Synthesis of Low Surface Energy Group-Containing Polymerizable Component

### (a) Synthesis of IPDI Adduct

After 222 parts by mass of isophorone diisocyanate (IPDI) was heated to 80° C. in a 1 L four-necked flask under air, 116 parts by mass of 2-hydroxyethyl acrylate and 0.13 parts by mass of hydroquinone were dropped thereinto taking 2 hours, and reaction was carried out at 80° C. for 3 hours. Thus, a compound [X] (IPDI adduct) containing one isocyanate group and one vinyl group was obtained.

### (b) Synthesis of Polymer 1

15 parts by mass of a polysiloxane compound containing a methacryloxy group on one terminal (“Silaplane FM-0721” from CHISSO Corporation), 70 parts by mass of 2-hydroxyethyl methacrylate, 15 parts by mass of butyl methacrylate and 200 parts by mass of methyl isobutyl ketone (MIBK) were fed into a four-necked flask provided with a cooling tube, a stirring device and a thermometer; stirred under a nitrogen gas stream while the temperature was raised to 80° C.; subjected to polymerization reaction for 2 hours with 3 parts by mass of azobisisobutyronitrile added thereto; and further subjected to polymerization reaction for 2 hours with 1 part by mass of azobisisobutyronitrile added thereto. Next, a solution of 204 parts by mass of the compound [X] (IPDI adduct) and 1 part by mass of tin octylate dissolved with 20 parts by mass of methyl ethyl ketone (MEK) was dropped thereinto taking about 10 minutes, and after the dropping, reaction was carried out for 2 hours. To the obtained solution, cyclohexanone was added in such away that the nonvolatile content became 10 percent by mass. Thus, a polymer 1 was obtained. The weight average molecular weight of the polymer 1 was about 20,000.

### (3-2) Preparation of Surface-Treated Metal Oxide Particle

To 100 parts by volume of alumina particles having a number average primary particle size of 34 nm, 15 parts by volume of a surface treatment agent 1 (modified silicone oil with carbinol on one terminal (“X-22-170BX” from Shin-Etsu Chemical Co., Ltd.) and 400 parts by volume of a solvent (a mixed solvent of toluene:isopropanol=1:1 (volume ratio)) were mixed, dispersion was carried out with a wet media dispersion-type apparatus so as to remove the solvent, and drying was carried out at 150° C. for 30 minutes. Thus, a surface-treated metal oxide particle 1 was obtained.

### (3-3) Preparation of Surface Layer-Forming Application Liquid

| | |
|---|---|
| Polyfunctional (meth)acrylate: dipentaerythritol | 25 parts by volume |
| hexaacrylate (DPHA) | |
| Polyurethane acrylate: “UV-3000B” | 50 parts by volume |
| (from the Nippon Synthetic Chemical Industry Co., | |
| Ltd.) | |
| Low surface energy group-containing polymerizable | 25 parts by volume |
| component: polymer 1 | |
| Metal oxide particle 1 | 5 parts by volume |

The above were dissolved and dispersed in a solvent of propylene glycol monomethyl ether acetate (PMA) in such a way that the solid content concentration became 10 percent by mass. Thus, a surface layer-forming application liquid 1 was obtained.

### (3-4) Formation of Surface Layer

To 100 parts by mass of the surface layer-forming application liquid 1, 0.5 parts by mass of a polymerization initiator (2,4,6-trimethylbenzoyl-diphenyl-phosphineoxide) was added and dissolved. The resulting product was applied onto the outer circumferential face of the above-described elastic body layer by immersion application using the application apparatus shown in FIG. 3 under the application condition below so as to form a coating having a dry thickness of 5 μm, and the coating was irradiated with ultraviolet rays as active energy rays under the irradiation conditions below so as to be cured. Thus, a surface layer 1 was formed. Consequently, a transfer member 1 was obtained. The irradiation with ultraviolet rays was carried out as follows; a light source was fixed, nitrogen substitution was carried out in such a way that the oxide concentration became 500 ppm or less, and the irradiation was carried out through a 3 mm borosilicate glass to cut ultraviolet rays of 320 nm or less while the substrate having the coating formed on the outer circumferential face of the elastic body layer 1 was rotated at a peripheral velocity of 60 mm/s.

### —Application Condition—

Application Liquid Supply Amount: 1 L/min

### —Ultraviolet Ray Irradiation Conditions—

Type of Light Source: high-pressure mercury lamp “H04-L41” (from Eye Grapphics Co., Ltd.)

Distance from Irradiation Port to Surface of Coating: 100 mm

Irradiation Light Amount: 1 J/cm²

Irradiation Time (Substrate Rotation Time): 240 seconds

With regard to the obtained transfer member 1, the indentation depth and the hardness were measured with the above-described measurement methods. The result is shown in TABLE 1.

### Transfer Member Manufacturing Examples 2 to 8

Transfer members 2 to 8 were manufactured in the same way as the transfer member 1, but surface layer-forming application liquids 2 to 8 were prepared according to the prescriptions shown in TABLE 1 and used for forming surface layers 2 to 8, respectively. With regard to the obtained transfer members 2 to 8, the indentation depth and the hardness were measured with the above-described measurement methods. The result is shown in TABLE 1.

### Transfer Member Manufacturing Example 9

A transfer member 9 was manufactured in the same way as the transfer member 1, but a surface layer-forming application liquid 9 of PVDF-HFP copolymer resin “Kynar FLEX 2851” (from Arkema K.K.) dissolved in a solvent of dimethylacetamide in such a way that the solid content concentration became 10 percent by mass was used and applied onto the outer circumferential face of an elastic body layer 9 and dried at 150° C. for 30 minutes. With regard to the obtained transfer member 9, the indentation depth and the hardness were measured with the above-described measurement methods. The result is shown in TABLE 1.

### Transfer Member Manufacturing Example 10

A transfer member 10 was manufactured in the same way as the transfer member 1, but a surface layer was not formed and an elastic body layer 10 was subjected to UV treatment (with an irradiation intensity of 100 mW/cm² for 10 seconds) as surface treatment. With regard to the obtained transfer member 10, the indentation depth and the hardness were measured with the above-described measurement methods. The result is shown in TABLE 1.

Elastic body materials 2 and 3 under the “Elastic Body Layer” of TABLE 1 were obtained according to the prescriptions shown in TABLE 2.

Polymers 2 to 4 under the “Low Surface Energy Group-Containing Polymerizable Component” of TABLE 1 were obtained with the synthesis methods described below.

Metal oxide particles 2 to 5 in TABLE 1 were prepared in the same way as the surface-treated metal oxide particle 1, except that the type of the untreated metal oxide particle and the type of the surface treatment agent were changed to those shown in TABLE 1. The surface treatment agent 2 was modified silicone oil with diol on one terminal “X-22-176DX” (from Shin-Etsu Chemical Co., Ltd.), the surface treatment agent 3 was methylhydrogenpolysiloxane “KF-9901” (from Shin-Etsu Chemical Co., Ltd.), and the surface treatment agent 4 was 3-acryloxypropyl trimethoxysilane “KBM-5103” (from Shin-Etsu Chemical Co., Ltd.).

### <Synthesis of Polymer 2>

20 parts by mass of a polysiloxane compound containing a methacryloxy group on one terminal (“Silaplane FM-0721” from CHISSO Corporation), 70 parts by mass of glycidyl methacrylate, 10 parts by mass of butyl methacrylate and 200 parts by mass of methyl isobutyl ketone (MIBK) were fed into a four-necked flask provided with a cooling tube, a stirring device and a thermometer; stirred under a nitrogen gas stream while the temperature was raised to 90° C.; subjected to polymerization reaction for 2 hours with 3 parts by mass of azobisisobutyronitrile added thereto; and further subjected to polymerization reaction for 2 hours with 1 part by mass of azobisisobutyronitrile added thereto. Next, the temperature was raised to 100° C., the inflow gas was changed from nitrogen to air, and 0.7 parts by mass of dimethylbenzylamine was added. Thereafter, 35 parts by mass of acrylic acid was dropped taking about 10 minutes, and after the dropping, reaction was carried out for 10 hours. To the obtained solution, cyclohexanone was added in such a way that the nonvolatile content became 10 percent by mass. Thus, a polymer 2 was obtained. The weight average molecular weight of the polymer 2 was about 17,000.

### <Synthesis of Polymer 3>

25 parts by mass of a polysiloxane compound containing a methacryloxy group on one terminal (“Silaplane FM-0721” from CHISSO Corporation), 30 parts by mass of methacryloyloxyethyl isocyanate, 45 parts by mass of butyl methacrylate and 200 parts by mass of methyl ethyl ketone (MEK) were fed into a four-necked flask provided with a cooling tube, a stirring device and a thermometer; stirred under a nitrogen gas stream while the temperature was raised to 80° C.; subjected to polymerization reaction for 2 hours with 1.6 parts by mass of azobisisobutyronitrile added thereto; and further subjected to polymerization reaction for 2 hours with 0.4 parts by mass of azobisisobutyronitrile added thereto. Next, a solution of 25.2 parts by mass of 2-hydroxyethyl methacrylate and 0.6 parts by mass of tin octylate dissolved with 20 parts by mass of methyl ethyl ketone (MEK) was dropped thereinto taking about 10 minutes, and after the dropping, reaction was carried out for 2 hours. To the obtained solution, cyclohexanone was added in such away that the nonvolatile content became 20 percent by mass. Thus, a polymer 3 was obtained. The weight average molecular weight of the polymer 3 was about 24,000.

### <Synthesis of Polymer 4>

20 parts by mass of a polysiloxane compound containing a methacryloxy group on one terminal (“Silaplane FM-0711” from CHISSO Corporation), 70 parts by mass of glycidyl methacrylate, 10 parts by mass of butyl methacrylate and 200 parts by mass of methyl isobutyl ketone (MIBK) were fed into a four-necked flask provided with a cooling tube, a stirring device and a thermometer; stirred under a nitrogen gas stream while the temperature was raised to 90° C.; subjected to polymerization reaction for 2 hours with 3 parts by mass of azobisisobutyronitrile added thereto; and further subjected to polymerization reaction for 2 hours with 1 part by mass of azobisisobutyronitrile added thereto. Next, the temperature was raised to 100° C., the inflow gas was changed from nitrogen to air, and 0.7 parts by mass of dimethylbenzylamine was added. Thereafter, 35 parts by mass of acrylic acid was dropped taking about 10 minutes, and after the dropping, reaction was carried out for 10 hours. To the obtained solution, cyclohexanone was added in such a way that the nonvolatile content became 10 percent by mass. Thus, a polymer 4 was obtained. The weight average molecular weight of the polymer 4 was about 15,000.

In the transfer member of the present invention, specific gravities of the components of the surface layer are calculated as follows: about 1.1 for the organic matters, or to be more specific, 1.18 for DPHA, 1.11 for TMPTA, 1.1 for polyurethane acrylate and 1.1 for the low surface energy group-containing polymerizable component; and as the metal oxide particles, 3.5 for alumina, 6.3 for tin oxide, 3.7 for titania and 2.2 for silica.

TABLE 1

| | | | | SURFACE LAYER | | | | | | |
|---|---|---|---|---|---|---|---|---|---|---|
| | | | | | | | | | LOW | |
| | ELASTIC BODY LAYER | | | | | | | | SURFACE ENERGY | |
| | | ELASTIC | | | POLYFUNCTIONAL | | | | GROUP-CONTAINING | |
| TRANSFER | | BODY | | | (METH) | | POLYURETHAN | | POLYMERIZABLE | |
| MEMBER | | MATERIAL | THICKNESS | | ACRYLATE | | ACRYLATE | | COMPONENT | |
| No | No. | No | (μm) | No. | TYPE | *1 | TYPE | *1 | TYPE | *1 |
| 1 | 1 | 1 | 300 | 1 | DPHA | 25 | UV-3000B, | 50 | POLYMER 1 | 25 |
| | | | | | | | *2; 18000, *3 | | | |
| 2 | 2 | 2 | 200 | 2 | DPHA | 15 | UV-3000B, | 10 | POLYMER 2 | 15 |
| | | | | | | | *2; 18000, *3 | | | |
| 3 | 3 | 3 | 200 | 3 | TMPTA | 20 | UV-2750B | 60 | POLYMER 3 | 20 |
| | | | | | | | *2; 3000, *3 | | | |
| 4 | 4 | 1 | 250 | 4 | TMPTA | 25 | UV-3520TL, | 68 | POLYMER 4 | 15 |
| | | | | | | | *2; 14000, *3 | | | |
| 5 | 5 | 1 | 200 | 5 | DPHA | 35 | UV-3000B, | 40 | POLYMER 1 | 25 |
| | | | | | | | *2; 18000, *3 | | | |
| 6 | 6 | 1 | 50 | 6 | DPHA | 25 | UV-3000B, | 50 | POLYMER 1 | 25 |
| | | | | | | | *2; 18000, *3 | | | |
| 7 | 7 | 1 | 600 | 7 | DPHA | 25 | UV-3000B, | 50 | POLYMER 1 | 25 |
| | | | | | | | *2; 18000, *3 | | | |
| 8 | 8 | 1 | 200 | 8 | DPHA | 90 | — | — | POLYMER 1 | 10 |
| 9 | 9 | 3 | 200 | 9 | — | — | — | — | — | — |
| 10 | 10 | 2 | 200 | — | — | — | — | — | — | — |

| | SURFACE LAYER | | | | | | |
|---|---|---|---|---|---|---|---|
| | | METAL OXIDE PARTICLE | | | | | |
| TRANSFER | | | SURFACE | | | | INDENTATION |
| MEMBER | | | TREATMENT | | THICKNESS | HARDNESS | DEPTH |
| No | No | TYPE | AGENT | *1 | (μm) | ( [symbol] ) | (nm) |
| 1 | 1 | ALUMINA | TREATMENT | 5 | 5 | 63 | 700 |
| | | | AGENT 1 | | | | |
| 2 | 1 | ALUMINA | TREATMENT | 20 | 6 | 75 | 800 |
| | | | AGENT 1 | | | | |
| 3 | 2 | TIN OXIDE | TREATMENT | 10 | 4 | 12 | 700 |
| | | | AGENT 2 | | | | |
| 4 | 3 | TITANIA | TREATMENT | 15 | 3 | 70 | 600 |
| | | | AGENT 3 | | | | |
| 5 | 4 | SILICA | TREATMENT | 30 | 2 | 81 | 1100 |
| | | | AGENT 1 | | | | |
| 6 | 1 | ALUMINA | TREATMENT | 15 | 2 | 97 | 300 |
| | | | AGENT 1 | | | | |
| 7 | 5 | ALUMINA | TREATMENT | 10 | 5 | 49 | 2000 or more |
| | | | AGENT 4 | | | | |
| 8 | 5 | ALUMINA | TREATMENT | 10 | 8 | 75 | 200 |
| | | | AGENT 4 | | | | |
| 9 | — | — | — | — | 10 | 72 | 1800 |
| 10 | — | — | — | — | — | 80 | 1500 |

DPHA: DIPENTAERYTHRITOL HEXAACRYLATE
TMPTA: TRIMETHYLOLPROPANE TRIACRYLATE
*1: ADDITION(parts by volume)
*2: NUMBER AVERAGE MOLECULAR WEIGHT
*3: FROM NIPPON SYNTHETIC CHEMICAL INDUSTRY CO. LTD. [symbol]
indicates data missing or illegible when filed

TABLE 2

| | | | | ALUMINUM | |
|---|---|---|---|---|---|
| ELASTIC BODY | RUBBER POLYMER | | CARBON BLACK | HYDROXIDE | SILICA |
| MATERIAL | | ADDITION | ADDITION | ADDITION | ADDITION |
| No. | TYPE | (parts by mass) | (parts by mass) | (parts by mass) | (parts by mass) |
| 1 | S-40A FROM | 100 | 40 | 40 | 20 |
| | DENKI KAGAKU KOGYO | | | | |
| | KABUSIKI KAISHA | | | | |
| 2 | S-40A FROM | 100 | 25 | 30 | 10 |
| | DENKI KAGAKU KOGYO | | | | |
| | KABUSIKI KAISHA | | | | |
| 1 | DCR-40A FROM | 100 | 30 | 30 | 10 |
| | DENKI KAGAKU KOGYO | | | | |
| | KABUSIKI KAISHA | | | | |

| | | | | | VULCANIZATION |
|---|---|---|---|---|---|
| ELASTIC BODY | TALC | PROCESS OIL | MAGNESIUM OXIDE | ZINC OXIDE | ACCELERATOR |
| MATERIAL | ADDITION | ADDITION | ADDITION | ADDITION | ADDITION |
| No. | (parts by mass) | (parts by mass) | (parts by mass) | (parts by mass) | (parts by mass) |
| 1 | 10 | 2 | 4 | 5 | 1 |
| 2 | 10 | 2 | 4 | 5 | 1 |
| 1 | 10 | 2 | 4 | 5 | 1 |

### [Evaluation 1: Scratch by Paper Edge]

Each of the obtained transfer members 1 to 10 was installed in an image forming apparatus “bizhub PRO C6500” (from Konica Minolta, Inc.) as an intermediate transfer body, one million sheets of paper each having a thickness of 400 μm were made to pass through the image forming apparatus, and scratches in a region of the transfer member corresponding to the edge of paper were observed for evaluation. The evaluation was made according to the criteria below. The result is shown in TABLE 3.

### —Evaluation Criteria—

⊚ (double circle): the number of scratches after outputting one million sheets=0

∘ (single circle): 1≦ the number of scratches after outputting one million sheets <6

Δ (triangle): 6≦ the number of scratches after outputting one million sheets <11

× (cross): 11≦ the number of scratches after outputting one million sheets

### [Evaluation 2: Scratch Resistance]

Each of the obtained transfer members 1 to 10 was installed in an image forming apparatus “bizhub PRO C6500” (from Konica Minolta, Inc.) as an intermediate transfer body, an image of yellow (Y), magenta (M), cyan (C) and black (Bk) each having a coverage rate of 2.5% was printed on one million sheets of neutral paper under a temperature of 20° C. and a humidity of 50% RH, and the surface state of the transfer member was observed before and after the printing for evaluation. The evaluation was made according to the number of scratches in a region of 100 mm×100 mm. The result is shown in TABLE 3.

### —Evaluation Criteria—

⊚ (double circle): the number of scratches after outputting one million sheets=0

∘ (single circle): 1≦ the number of scratches after outputting one million sheets <6

Δ (triangle): 6≦ the number of scratches after outputting one million sheets <11

× (cross): 11≦ the number of scratches after outputting one million sheets

### [Evaluation 3: Transferability to Uneven Paper]

Each of the obtained transfer members 1 to 10 was installed in an image forming apparatus “bizhub PRO C6500” (from Konica Minolta, Inc.) as an intermediate transfer body, an image having a toner density of 100% (solid image) was printed on uneven paper (leather-like paper), and the image density was measured for evaluation. As the image density, an average density was calculated from an image which was scanned using a scanner and subjected to image processing with Photoshop (from Adobe Systems Incorporated). The evaluation was made according to the criteria below. The result is shown in TABLE 3.

### —Evaluation Criteria—

⊚ (double circle): the ratio of the area having an average density of 90% or less ≦1.5%

∘ (single circle): 1.5%< the ratio of the area having an average density of 90% or less ≦3%

Δ (triangle): 3%< the ratio of the area having an average density of 90% or less ≦5%

× (cross): 5%< the ratio of the area having an average density of 90% or less ≦10%

TABLE 3

| | | EVALUATION | | |
|---|---|---|---|---|
| | TRANS- | | | TRANSFER- |
| | FER | SCRATCH | SCRATCH | ABILTY |
| | MEMBER | BY PAPER | RESIS- | TO UNEVEN |
| | NO. | EDGE | TANCE | PAPER |
| EXAMPLE 1 | 1 | ⊚ | ⊚ | ⊚ |
| EXAMPLE 2 | 2 | ◯ | Δ | ◯ |
| EXAMPLE 3 | 3 | Δ | ⊚ | ◯ |
| EXAMPLE 4 | 4 | ◯ | ◯ | ◯ |
| EXAMPLE 5 | 5 | ⊚ | ⊚ | ◯ |
| COMPAR- | 6 | ◯ | ◯ | X |
| ATIVE | | | | |
| EXAMPLE 1 | | | | |
| COMPAR- | 7 | X | ◯ | ◯ |
| ATIVE | | | | |
| EXAMPLE 2 | | | | |
| COMPAR- | 8 | X | X | Δ |
| ATIVE | | | | |
| EXAMPLE 3 | | | | |
| COMPAR- | 9 | ◯ | ◯ | X |
| ATIVE | | | | |
| EXAMPLE 4 | | | | |
| COMPAR- | 10 | ◯ | Δ | X |
| ATIVE | | | | |
| EXAMPLE 5 | | | | |

This application is based upon and claims the benefit of priority under 35 USC 119 of Japanese Patent Application No. 2014-020167 filed on Feb. 5, 2014, the entire disclosure of which, including the specification, claims, drawings and abstract, is incorporated herein by reference in its entirety.

What is claimed is:

1. An endless belt-shaped transfer member of an electrophotographic image forming apparatus, the transfer member comprising:
an elastic body layer; and
a surface layer formed on the elastic body layer, wherein
the transfer member has (i) an indentation depth of 400 nm or more and 1,500 nm or less with a load of 100 μN applied to a surface of the transfer member with a Berkovich indenter and (ii) a hardness of 40° or more and 85° or less on the surface of the transfer member measured with a micro-rubber hardness tester.

2. The transfer member according to claim 1, wherein
the surface layer contains cured (meth)acrylic resin and a surface-treated metal oxide particle, and
the cured (meth)acrylic resin is obtained by curing a curable composition containing polyfunctional (meth)acrylate, polyurethane acrylate and a low surface energy group-containing polymerizable component.

3. The transfer member according to claim 2, wherein the polyurethane acrylate has a number average molecular weight of 3,000 and more and 30,000 or less.

4. The transfer member according to claim 2, wherein the polyfunctional (meth)acrylate is tri- or higher-functional (meth)acrylate.

5. The transfer member according to claim 2, wherein the polyfunctional (meth)acrylate has a number average molecular weight of 3,000 or less.

6. The transfer member according to claim 2, wherein a content of a structural unit derived from the polyfunctional (meth)acrylate in the curable composition is 20 to 60 percent by mass.

7. The transfer member according to claim 2, wherein a (meth)acryloyl group of the polyurethane acrylate is present on a terminal of a molecular chain.

8. The transfer member according to claim 2, wherein a content of a structural unit derived from the polyurethane acrylate in the curable composition is 30 to 70 percent by mass.

9. The transfer member according to claim 2, wherein the low surface energy group-containing polymerizable component contains a polyorganosiloxane chain or a polyfluoroalkyl chain.

10. The transfer member according to claim 2, wherein the low surface energy group-containing polymerizable component contains three or more radical polymerizable double bonds.

11. The transfer member according to claim 2, wherein the low surface energy group-containing polymerizable component has a number average molecular weight of 5,000 or more and 100,000 or less.

12. The transfer member according to claim 2, wherein the metal oxide particle has a number average primary particle size of 1 nm or more and 300 nm or less.

13. The transfer member according to claim 2, wherein the metal oxide particle is surface-treated with silicone oil.

14. The transfer member according to claim 2, wherein the metal oxide particle is surface-treated with a radical polymerizable functional group-containing silane coupling agent.

15. The transfer member according to claim 1, wherein the surface layer has a thickness of 1 μm or more and 5 μm or less.

16. The transfer member according to claim 1, wherein the surface layer is cured by being irradiated with an active energy ray and thereby is formed.

17. The transfer member according to claim 1, wherein a polymerization initiator used for curing the surface layer and thereby forming the surface layer is an acylphosphine oxide compound.

18. The transfer member according to claim 1, wherein the elastic body layer contains chloroprene rubber.

19. An electrophotographic image forming apparatus comprising:
a primary transfer section which primary-transfers a toner image electrostatically formed on an image holder to an intermediate transfer belt which circularly moves; and
a secondary transfer section which secondary-transfers the toner image primary-transferred to the intermediate transfer belt to an image support, wherein
the intermediate transfer belt is constituted of the transfer member according to claim 1.
